(19) United States
(12) Patent Application Publication
(10) Pub. No.: US 2025/0086764 A1
(43) Pub. Date: Mar. 13, 2025

(54) TECHNIQUES FOR ADJUSTING GAIN MAPS FOR DIGITAL IMAGES

(71) Applicant: Apple Inc., Cupertino, CA (US)

(72) Inventors: Maryam AZIMI HASHEMI, Mountain View, CA (US); Garrett M. JOHNSON, San Francisco, CA (US); Ilya ROMANENKO, Foxton (GB); Nicolas P. BONNIER, Mountain View, CA (US); Paul M. HUBEL, Mountain View, CA (US)

(21) Appl. No.: 18/770,149

(22) Filed: Jul. 11, 2024

Related U.S. Application Data
(60) Provisional application No. 63/582,235, filed on Sep. 12, 2023.

(51) Int. Cl. G06T 5/92; G06T 5/40; G06V 10/50; G06V 10/60; G06V 10/764

(52) U.S. Cl. CPC G06T 5/92; G06T 5/40; G06V 10/50; G06V 10/60; G06T 2207/10144; G06T 2207/20208; G06T 2207/30196; G06V 10/764; G06V 2201/10

(57) ABSTRACT

The embodiments described herein set forth techniques for adjusting gain maps for digital images. In particular, headroom metrics, midtone metrics, highlight metrics, shadow metrics, diffuse white metrics, etc., or some combination thereof, can be determined based on characteristics of a given digital image, characteristics of a scene that corresponds to the digital image, circumstances under which the scene was captured, and so on. These metrics, or some combination thereof, can then be used to modify a gain map associated with the digital image. Additionally, a histogram of the modified gain map can be generated, where, in turn, the histogram can be used to modify any of the aforementioned metrics. Subsequently, the histogram and/or any combination of the modified metrics can be used to adjust the modified gain map.

### CROSS-REFERENCE TO RELATED APPLICATIONS

The present application claims the benefit of U.S. Provisional Application No. 63/582,235, entitled “TECHNIQUES FOR ADJUSTING GAIN MAPS FOR DIGITAL IMAGES,” filed Sep. 12, 2023, the content of which is incorporated by reference herein in its entirety for all purposes.

### FIELD OF INVENTION

The described embodiments relate generally to digital photography. More particularly, the described embodiments provide techniques for adjusting a gain map for a given digital image based on metrics that are derived from characteristics of the digital image, characteristics of a scene that corresponds to the digital image, circumstances under which the scene was captured, and the like.

### BACKGROUND

The dynamic range of an image refers to the range of pixel values between the image's lightest and darkest parts (often referred to as “luminance”). Notably, conventional image sensors can only capture a limited range of luminance in a single exposure of a scene, at least relative to what human eyes are able to perceive from the same scene. This limited range is typically referred to as standard dynamic range (SDR) in the world of digital photography.

Despite the foregoing image sensor limitations, improvements in photography techniques have enabled wider ranges of light to be captured (referred to herein as high dynamic range (HDR)). This can be achieved by (1) capturing multiple “brackets” of images, i.e., images with different exposure times (also called “stops”), and then (2) fusing the bracketed images into a single image that incorporates different aspects of the different exposures. In this regard, the single HDR image possesses a wider dynamic range of luminance in comparison to what otherwise can be captured in each of the individual exposures. This makes HDR images superior to SDR images in several aspects.

Accordingly, what is needed is a technique for improving the manner in which HDR images are captured, processed, and ultimately displayed on display devices.

### SUMMARY OF INVENTION

The described embodiments relate generally to digital photography. More particularly, the described embodiments provide techniques for adjusting a gain map for a given digital image based on metrics that are derived from characteristics of the digital image, characteristics of a scene that corresponds to the digital image, circumstances under which the scene was captured, and the like.

One embodiment sets forth a method for processing a digital image. According to some embodiments, the method can be implemented by a computing device, and includes the steps of (1) receiving the digital image from an input source with which the computing device is communicatively coupled, wherein the digital image includes: (i) pixel information, and (ii) metadata that defines a plurality of properties of the digital image, (2) determining headroom metrics, midtone metrics, highlight metrics, shadow metrics, diffuse white metrics, or some combination thereof, based on the digital image, (3) adjusting a gain map for the digital image based on the headroom, midtone, highlight, shadow, diffuse white metrics, or some combination thereof, to produce a modified gain map, (4) producing a supplemental digital image based on the digital image and the modified gain map, and (5) causing the supplemental digital image to be output on a display device.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of a computing device that can be configured to perform the various techniques described herein, according to some embodiments.

FIGS. 2A-2B illustrate a method for processing a digital image, according to some embodiments.

FIGS. 3A-3C illustrate a sequence of conceptual diagrams of a technique for processing a digital image, according to some embodiments.

FIG. 4 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

The embodiments described herein set forth techniques for adjusting gain maps for digital images. In particular, headroom metrics, midtone metrics, highlight metrics, shadow metrics, diffuse white metrics, etc., or some combination thereof, can be determined based on characteristics of a given digital image, characteristics of a scene that corresponds to the digital image, circumstances under which the scene was captured, and so on. These metrics, or some combination thereof, can then be used to modify a gain map associated with the digital image. Additionally, a histogram of the modified gain map can be generated, where, in turn, the histogram can be used to modify any of the aforementioned metrics. Subsequently, the histogram and/or any combination of the modified metrics can be used to adjust the modified gain map.

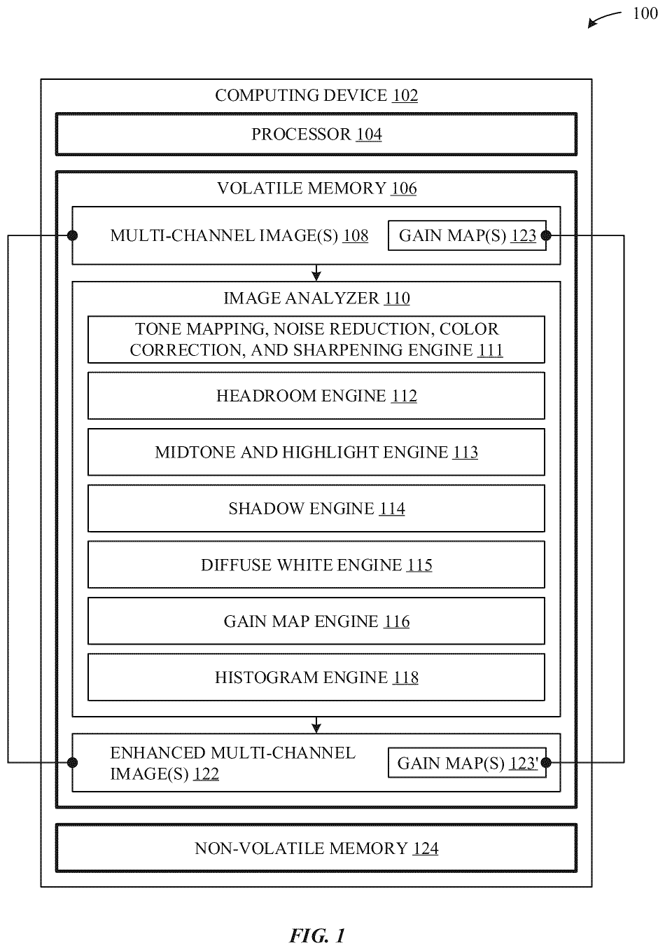

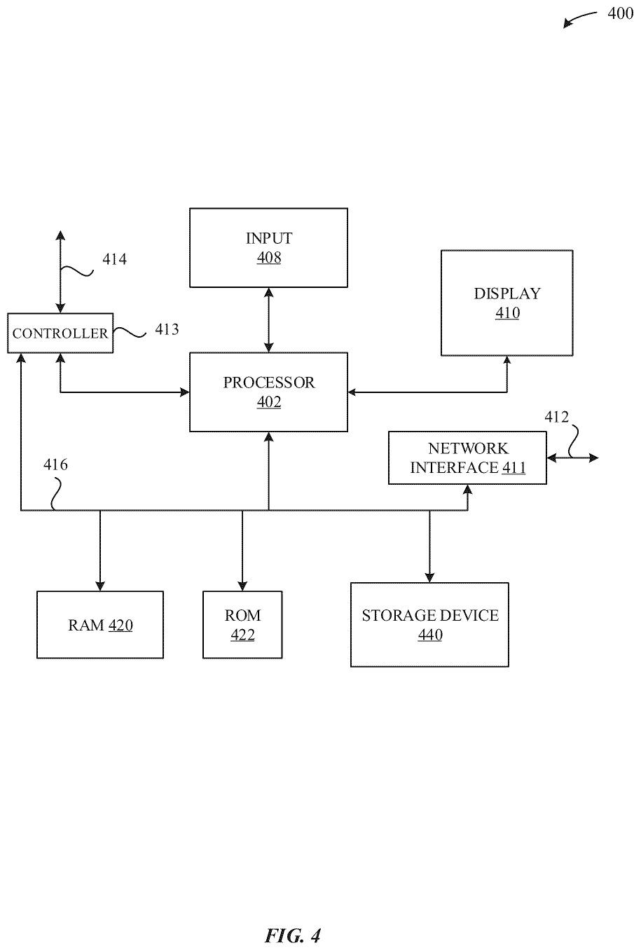

FIG. 1 illustrates an overview 100 of a computing device 102 that can be configured to perform the various techniques described herein. As shown in FIG. 1, the computing device 102 can include a processor 104, a volatile memory 106, and a non-volatile memory 124. It is noted that a more detailed breakdown of example hardware components that can be included in the computing device 102 is illustrated in FIG. 4, and that these components are omitted from the illustration of FIG. 1 in the interest of simplifying this disclosure. For example, the computing device 102 can include additional non-volatile memories (e.g., solid-state drives, hard drives, etc.), other processors (e.g., a multi-core central processing unit (CPU)), a graphics processing unit (GPU), and so on). According to some embodiments, an operating system (OS) (not illustrated in FIG. 1) can be loaded into the volatile memory 106, where the OS can execute a variety of applications that collectively enable the various techniques described herein to be implemented. For example, these applications can include an image analyzer 110, one or more compressors (not illustrated in FIG. 1), and so on.

As shown in FIG. 1, the volatile memory 106 can be configured to receive multiple-channel images 108. The multiple-channel images 108 can be provided, for example, by a digital imaging unit (not illustrated in FIG. 1) that is configured to capture and process digital images. According to some embodiments, a multiple-channel image 108 can be composed of a collection of pixels, where each pixel in the collection of pixels includes a group of sub-pixels (e.g., a red sub-pixel, a green sub-pixel, a blue sub-pixel, etc.). It is noted that the term “sub-pixel” used herein can be synonymous with the term “channel.” It is also noted that the multiple-channel images 108 can have different resolutions, layouts, bit-depths, and so on, without departing from the scope of this disclosure. According to some embodiments, each multiple-channel image 108 can include, in addition to the aforementioned pixel information, metadata that defines a plurality of properties of the multiple-channel image 108. Such properties can define, for example, characteristics of the multiple-channel image 108, characteristics of a scene that corresponds to the multiple-channel image 108, circumstances under which the scene was captured, and so on. It is noted that the foregoing examples are not meant to be limiting, and that the multiple-channel image 108 can include any amount, form, type, etc., of information, at any level of granularity, without departing from the scope of this disclosure.

According to some embodiments, a given multiple-channel image 108 can represent a standard dynamic range (SDR) image that constitutes a single exposure of a scene that is gathered and processed by the digital imaging unit. A given multiple-channel image 108 can also represent a high dynamic range (HDR) image that constitutes multiple exposures of a scene that are gathered and processed by the digital imaging unit. To generate an HDR image, the digital imaging unit may capture a scene under different exposure brackets, e.g., three exposure brackets that are often referred to as “EV0”, “EV−”, and “EV+”. Generally, the EV0 image corresponds to a normal/ideal exposure for the scene (typically captured using auto-exposure settings of the digital imaging unit); the EV− image corresponds to an under-exposed image of the scene (e.g., four times darker than EV0), and the EV+ image corresponds to an over-exposed image of the scene (e.g., four times brighter than EV0). The digital imaging unit can combine the different exposures to produce a resultant image that incorporates a greater range of luminance relative to SDR images. It is noted that the multiple-channel images 108 discussed herein are not limited to SDR/HDR images, and that the multiple-channel images 108 can represent any form, type, etc., of digital image (e.g., scanned images, computer-generated images, etc.), without departing from the scope of this disclosure.

As shown in FIG. 1, each multiple-channel image 108 can be associated with one or more gain maps 123. According to some embodiments, the gain maps 123 for a given multiple-channel image 108 can be generated by the digital imaging unit (or any other provider, engine, etc.), e.g., at a time of capture, subsequent to the time of capture, etc., and can include information that effectively enables a different multiple-channel image 108 to be generated using the multiple-channel image 108 and the gain maps 123. For example, if the multiple-channel image 108 constitutes an SDR image—and a gain map 123 represents the difference between the SDR image and a corresponding HDR image—then the HDR image can be derived using the SDR and the gain map 123. In another example, if the multiple-channel image 108 constitutes an HDR image—and a gain map 123 represents the difference between the HDR image and a corresponding SDR imagine—then the SDR image can be derived using the HDR image and the gain map 123. It is noted that the foregoing examples are not meant to be limiting, and that the gain maps 123 can store any information that enables a different multiple-channel image 108 to be derived from the gain map 123 and a corresponding multiple-channel image 108. For example, the gain maps 123 can be used to capture any number, type, form, etc., of adjustments made to a given multiple-channel image 108, without departing from the scope of this disclosure, to enable such adjustments to be applied, reversed, and so on.

As shown in FIG. 1, the multiple-channel images 108 can be provided to the image analyzer 110 after being gathered by the digital imaging unit. According to some embodiments, the image analyzer 110 can include various components that are configured to process/modify the multiple-channel images 108 as desired. For example, the image analyzer 110 can include an engine 111 that includes tone mapping capabilities (e.g., configured to perform global/local tone mapping operations, inverse tone mapping operations, etc.), noise reduction capabilities (e.g., configured to reduce global/local noise in the multiple-channel image), color correction capabilities (e.g., configured to perform global/local color corrections in the multiple-channel image), sharpening capabilities (e.g., configured to perform global/local sharpening corrections in the multiple-channel image), and so on. It is noted that image analyzer 110 is not limited to the aforementioned capabilities, and that the image analyzer 110 can incorporate any number, type, form, etc., of processing units, configured to perform any processing of/modifications to the multiple-channel images 108, any level of granularity, without departing from the scope of this disclosure. It is additionally noted that the aforementioned capabilities can be provided by other engines not illustrated in FIG. 1.

Additionally, and as shown in FIG. 1, the image analyzer 110 can include a headroom engine 112 that can analyze and manage the headroom of a given multiple-channel image 108. As disclosed herein, the term “headroom” pertains to the margin of brightness above the maximum intensity level that can be captured or displayed. In this context, headroom can play a crucial role in ensuring that details in highlights are preserved and not clipped or overexposed, which can otherwise result in loss of information and reduced digital image quality. Importantly, maintaining adequate headroom allows for post-processing adjustments, such as exposure correction and tone mapping, while minimizing the risk of irreparable highlight blowouts. In this regard, striking the right balance between preserving highlight detail and optimizing overall exposure can be important for producing high-quality digital images with accurate and visually pleasing tonal ranges.

Additionally, and as shown in FIG. 1, the image analyzer 110 can include a midtone and highlight engine 113 that can analyze and manage the midtones/highlights of a given multiple-channel image 108. As disclosed herein, “midtones” pertain to the tonal values that occupy the middle range of brightness levels within a digital image. Such tonal values can play an important role in defining the overall contrast and visual balance of a photograph or graphic composition. In this context, proper manipulation of midtones allows for adjustments in image exposure, contrast, and color balance, thereby enabling the enhancement of details and the creation of mood and atmosphere in the final image. In this regard, precise control of midtones through techniques such as curves adjustments or tonal mapping contributes significantly to the overall impact and quality of digital images.

Additionally, and as disclosed herein, “highlights” pertain to the brightest areas of a digital image, which often contain important details and reflections. Such highlights play a pivotal role in defining an image's visual impact, and can contribute to its overall composition, drama, and storytelling. In this context, proper management of highlights is essential to avoid overexposure, which can lead to loss of detail and an unnatural, harsh appearance. In this regard, highlights can function as a key element in the art of digital imaging, as they allow for creative expression and control over an image's luminance and visual narrative.

Additionally, and as shown in FIG. 1, the image analyzer 110 can include a shadow engine 114 that can analyze and manage the shadows of a given multiple-channel image 108. As disclosed herein, “shadows” pertain to the darker areas of a digital image that exist in contrast to the aforementioned highlights and midtones. Such shadows can play an important role in adding depth, dimension, and mood to a digital image. In this regard, shadows are integral to the creative process in digital imaging, contributing to the overall visual storytelling and the conveyance of emotions or narratives in the final artwork.

Additionally, and as shown in FIG. 1, the image analyzer 110 can include a diffuse white engine 115 that can analyze and manage the diffuse white characteristics of a given multiple-channel image 108. As disclosed herein, “diffuse white” functions as a reference point for the brightest highlight that can be captured or displayed in a digital image. It can therefore be an essential component for maintaining accurate color representation, as it serves as a neutral reference against which other colors and tones are perceived. For example, when calibrating cameras and monitors, photographers and digital artists often use diffuse white to ensure color accuracy and consistency in their work. In this regard, properly managing diffuse white can help prevent color casts, and help ensure that the brightest areas of an image appear natural and balanced, which can contribute significantly to the overall fidelity and quality of digital images.

Additionally, and as shown in FIG. 1, the image analyzer 110 can include a gain map engine 116 that can analyze, generate, adjust, etc., gain maps associated with a given multiple-channel image 108. As disclosed herein, a “gain map” can help correct and equalize image sensor response across different regions of a camera sensor or in various lighting conditions. As also disclosed herein, a gain map can also be used to produce one type of image based on another type of image, e.g., an HDR multiple-channel image 108 based on an SDR multiple-channel image 108 and a complementary gain map, an SDR multiple-channel image 108 based on an HDR multiple-channel image 108 and a complementary gain map, and so on. In this regard, applying gain maps can help ensure consistent and accurate color reproduction, especially when displaying multiple-channel images 108 on display devices that possess different color output capabilities.

Additionally, and as shown in FIG. 1, the image analyzer 110 can include a histogram engine 118 that can analyze, generate, adjust, etc., histograms associated with multiple-channel images 108, gain maps, and so on. As disclosed herein, a “histogram” can serve as a useful tool in assessing and understanding the distribution of pixel values within an image. In particular, histograms can provide a visual representation of a digital image's tonal range, as well as reveal the frequency of occurrence for each brightness level (e.g., from shadows to highlights). In this regard, histograms can function as an effective guide when seeking to adjust a digital image, gain map, etc., to achieve a desired tonal balance and to ensure that no critical image data is lost (e.g., in clipped highlights, crushed shadows, etc.).

As described herein, when a multiple-channel image 108 is obtained, the image analyzer 110 can process the multiple-channel image 108 to identify various metrics that can improve at least one of the gain maps 123 associated with the multiple-channel image 108. More specifically, and according to some embodiments, the various engines included in the image analyzer 110 can determine headroom metrics, midtone metrics, highlight metrics, shadow metrics, diffuse white metrics, or some combination thereof, for the multiple-channel image 108. According to some embodiments, the headroom engine 112 can determine the headroom metrics based on any aspect of the multiple-channel image 108, including its pixel data, metadata, and so on. According to some embodiments, the midtone and highlight engine 113 can determine the midtone/highlight metrics based on any aspect of the multiple-channel image 108, including its pixel data, metadata, and so on.

According to some embodiments, the shadow engine can determine the shadow metrics based on any aspect of the multiple-channel image 108, including its pixel data, metadata, and so on. For example, the shadow metrics can be based on image capture type properties derivable from the pixel data, stored in the metadata, and/or the like. Non-limiting examples of image capture types include single shot mode, continuous shooting mode, timed or delayed capture, bracketing, long exposure photography, time-lapse photography, high-speed photography, panoramic photography, HDR photography, composite photography, focus stacking, bracketed focus, daytime photography, night time photography, and so on.

According to some embodiments, the diffuse white engine 115 can determine the diffuse white metrics based on any aspect of the multiple-channel image 108, including its pixel data, metadata, and so on. for example, the diffuse white metrics can be based on at least one material property classifier associated with the digital image, and/or at least one semantic mask associated with the digital image, that are stored within the metadata. The material property classifier can specify, for example, one or more types of materials that are detected within the multiple-channel image 108, e.g., using machine-learning algorithms. The at least one semantic mask can identify, for example, people, animals, eyes, etc., captured in the multiple-channel image 108.

According to some embodiments, when one or more of the aforementioned metrics are determined, the gain map engine 116 can adjust at least one of the gain maps 123 based on the headroom, midtone, highlight, shadow, diffuse white metrics, or some combination thereof, to produce a modified gain map 123 (illustrated in FIG. 1 as gain map 123′). Additionally, and according to some embodiments, the histogram engine 118 can optionally generate a histogram for the modified gain map 123′. In turn, one or more of the engines in the image analyzer 110 can modify the headroom, midtone, highlight, shadow, diffuse white metrics, or some combination thereof, based on the histogram, to produce modified headroom, modified midtone, modified highlight, modified shadow, modified diffuse white metrics, or some combination thereof. In turn, the gain map engine 118 can adjust the modified gain map 123′ based on the histogram, the modified headroom, modified midtone, modified highlight, modified shadow, modified diffuse white metrics, or some combination thereof. In any case, an enhanced multi-channel image 122 can be derived from the multiple-channel image 108 and the gain map 123′, and subsequently displayed on a display device that is communicatively coupled to the computing device 102.

Additionally, and although not illustrated in FIG. 1, one or more compressors can be implemented on the computing device 102, for compressing the enhanced multiple-channel images 122. For example, the compressors can implement Lempel-Ziv-Welch (LZW)-based compressors, other types of compressors, combinations of compressors, and so on. Moreover, the compressor(s) can be implemented in any manner to establish an environment that is most efficient for compressing the enhanced multiple-channel images 122. For example, multiple buffers can be instantiated (where pixels can be pre-processed in parallel), and each buffer can be tied to a respective compressor such that the buffers can be simultaneously compressed in parallel as well. Moreover, the same or a different type of compressor can be tied to each of the buffers based on the formatting of the enhanced multiple-channel images 122.

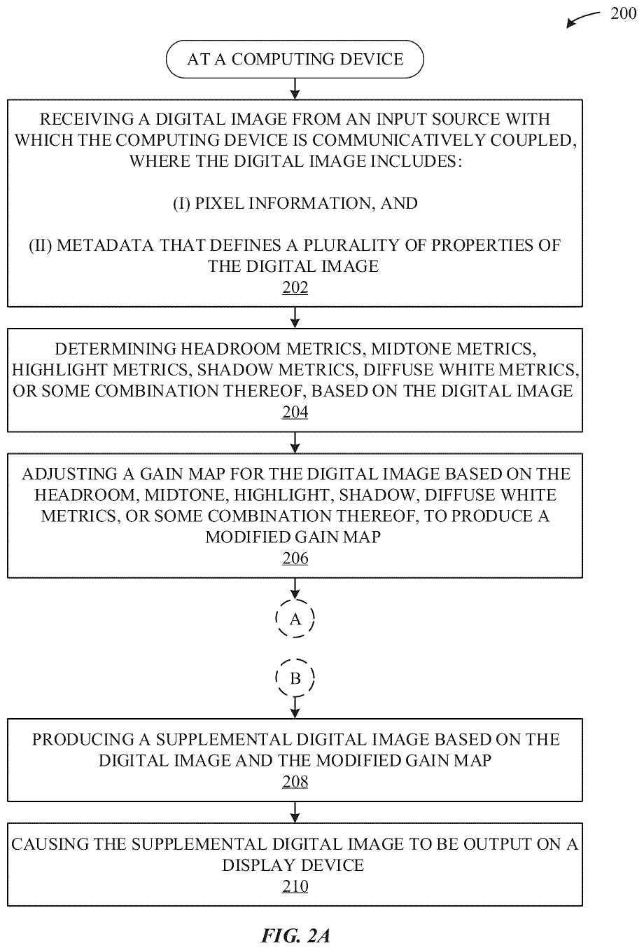

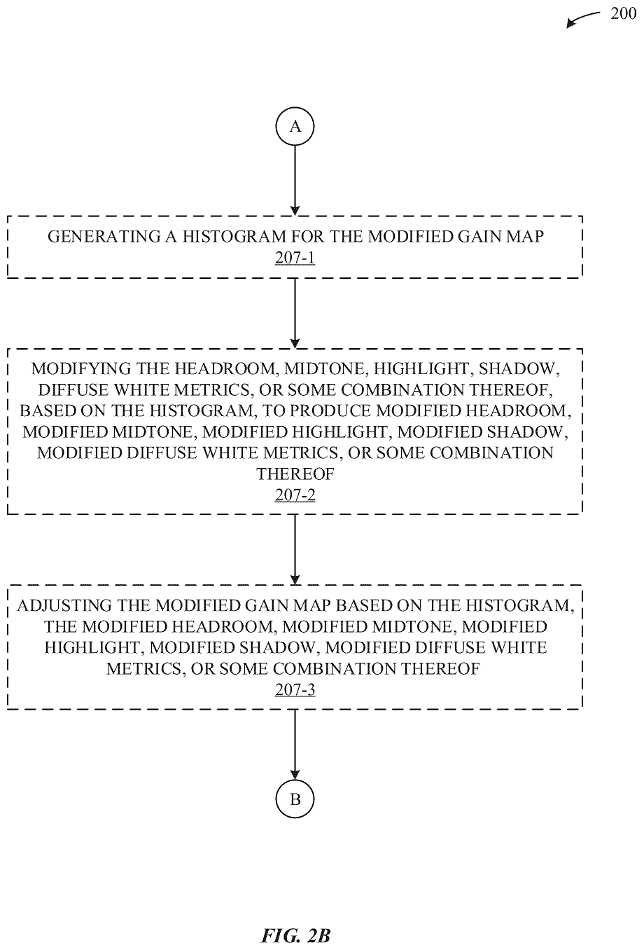

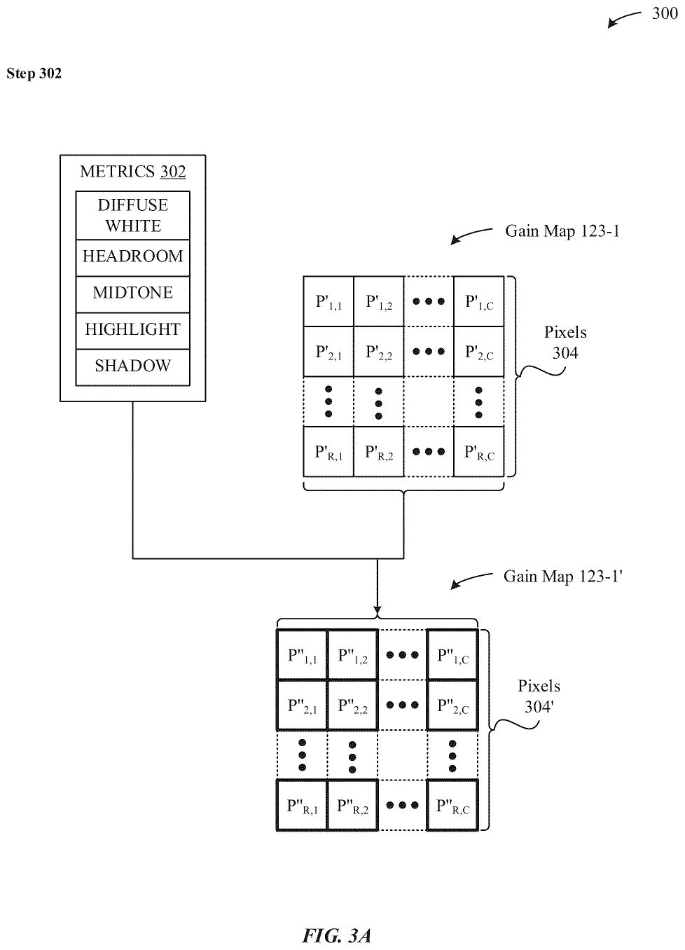

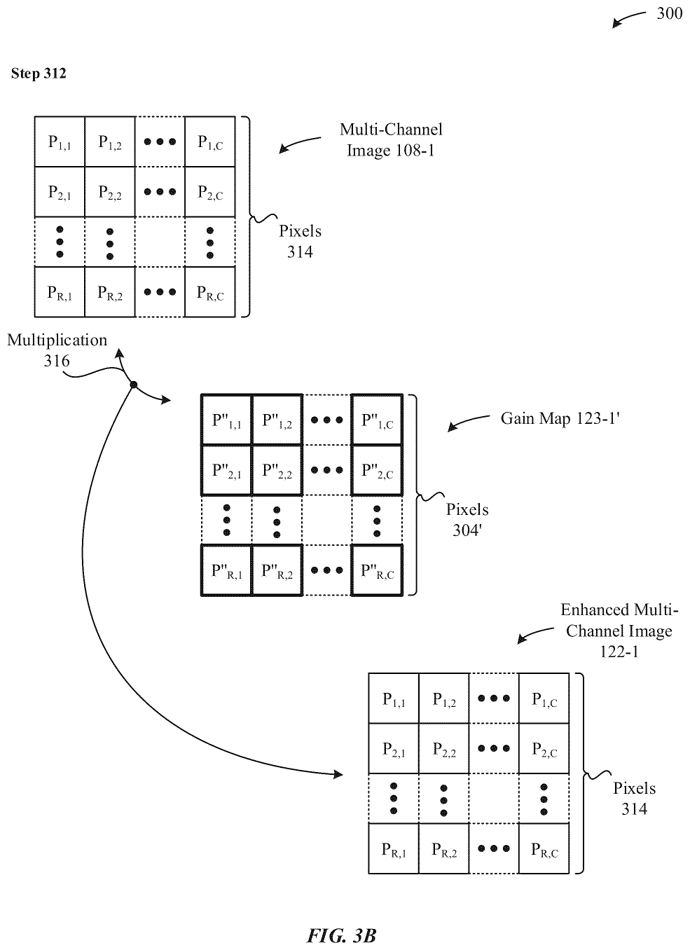

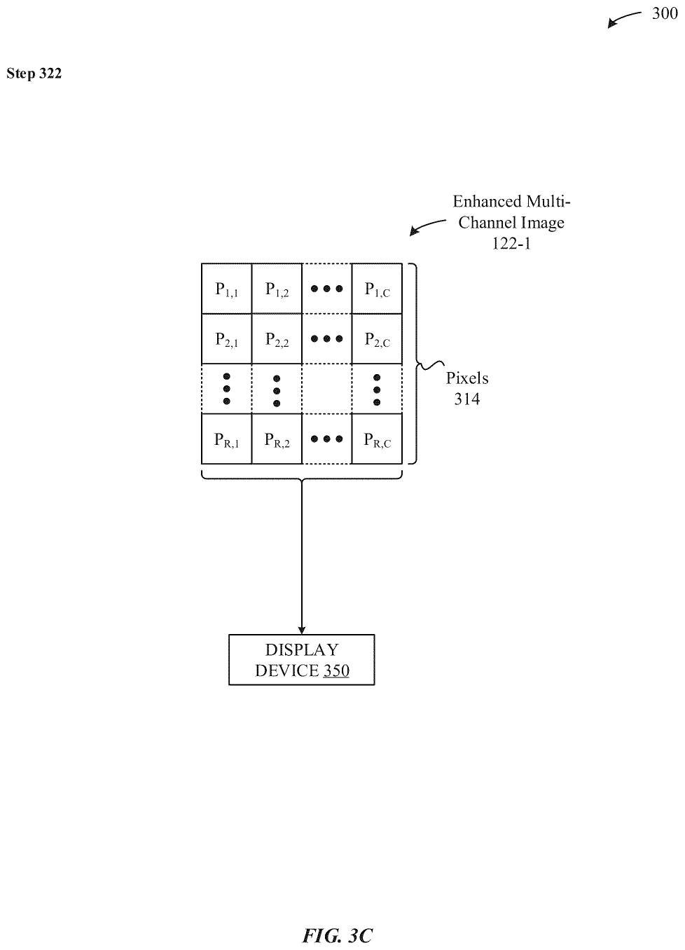

Accordingly, FIG. 1 provides a high-level overview of different hardware/software architectures that can be implemented by computing device 102 in order to carry out the various techniques described herein. A more detailed breakdown of these techniques will now be provided below in conjunction with FIGS. 2A-2B and 3A-3C.

FIGS. 2A-2B illustrate a method 200 for processing a digital image, according to some embodiments. As shown in FIG. 2A, the method 200 begins at step 202, where the computing device 102 receives a digital image from an input source with which the computing device is communicatively coupled, where the digital image includes: (i) pixel information, and (ii) metadata that defines a plurality of properties of the digital image (e.g., as described above in conjunction with FIG. 1).

At step 204, the computing device 102 determines headroom metrics, midtone metrics, highlight metrics, shadow metrics, diffuse white metrics, or some combination thereof, based on the digital image. Such determinations can be made, for example, using the various engines included in the image analyzer 110 described above in conjunction with FIG. 1.

At step 206, the computing device 102 adjusts a gain map for the digital image based on the headroom, midtone, highlight, shadow, diffuse white metrics, or some combination thereof, to produce a modified gain map (e.g., as also described above in conjunction with FIG. 1).

Turning now to FIG. 2B, at optional step 207-1, the computing device 102 generates a histography for the modified gain map. At optional step 207-2, the computing device 102 modifies the headroom, midtone, highlight, shadow, diffuse white metrics, or some combination thereof, based on the histogram, to produce modified headroom, modified midtone, modified highlight, modified shadow, modified diffuse white metrics, or some combination thereof. At optional step 207-3, the computing device 102 adjusts the modified gain map based on the histogram, the modified headroom, modified midtone, modified highlight, modified shadow, modified diffuse white metrics, or some combination thereof.

Turning back now to FIG. 2A, at step 208, the computing device 102 produces a supplemental digital image based on the digital image and the modified gain map (e.g., as also described above in conjunction with FIG. 1). At step 210, the computing device 102 causes the supplemental digital image to be output on a display device (e.g., as also described above in conjunction with FIG. 1).

FIGS. 3A-3C illustrate a sequence of conceptual diagrams of a technique for processing a digital image, according to some embodiments. In particular, FIG. 3A illustrates a step 302 where metrics 302—which include headroom metrics, midtone metrics, highlight metrics, shadow metrics, diffuse white metrics, or some combination thereof—are received for a multiple-channel image 108-1 (not illustrated in FIG. 3A, but illustrated in FIG. 3B). The metrics 302 can be determined, for example, by the image analyzer 110 implementing the techniques described above in conjunction with FIGS. 1 and 2A-2B (against the multiple-channel image 108-1).

As shown in FIG. 3A, a gain map 123-1 associated with the multiple-channel image 108-1 can be composed of pixels 304 (that correlate to the pixels of the multiple-channel image 108-1). According to some embodiments, and as described herein, the gain map 123-1 can be adjusted based on the headroom, midtone, highlight, shadow, diffuse white metrics, or some combination thereof, to produce a modified gain map 123-1′ (that includes modified pixels 304′).

Additionally, and although not illustrated in FIG. 3A, step 302 can involve generating a histogram for the modified gain map 123-1′, modifying the metrics 302 (i.e., the headroom, midtone, highlight, shadow, diffuse white metrics, or some combination thereof), based on the histogram, to produce modified metrics 302 (i.e., modified headroom, modified midtone, modified highlight, modified shadow, modified diffuse white metrics, or some combination thereof), and adjusting the modified gain map 123-1′ based on the histogram, the modified headroom, modified midtone, modified highlight, modified shadow, modified diffuse white metrics, or some combination thereof.

In any case, as shown in FIG. 3B, a step 312 involves producing an enhanced multi-channel image 122-1 (that includes pixels 314) based on the multiple-channel image 108-1 and the modified gain map 123-1′. The production can be performed, for example, through multiplication operations 316. In turn, and as shown in FIG. 3C, a step 322 involves displaying the enhanced multi-channel image 122-1 on a display device 350.

FIG. 4 illustrates a detailed view of a computing device 400 that can be used to implement the various techniques described herein, according to some embodiments. In particular, the detailed view illustrates various components that can be included in the computing device 102 described in conjunction with FIG. 1. As shown in FIG. 4, the computing device 400 can include a processor 402 that represents a microprocessor or controller for controlling the overall operation of the computing device 400. The computing device 400 can also include a user input device 408 that allows a user of the computing device 400 to interact with the computing device 400. For example, the user input device 408 can take a variety of forms, such as a button, keypad, dial, touch screen, audio input interface, visual/image capture input interface, input in the form of sensor data, and so on. Still further, the computing device 400 can include a display 410 that can be controlled by the processor 402 (e.g., via a graphics component) to display information to the user. A data bus 416 can facilitate data transfer between at least a storage device 440, the processor 402, and a controller 413. The controller 413 can be used to interface with and control different equipment through an equipment control bus 414. The computing device 400 can also include a network/bus interface 411 that couples to a data link 412. In the case of a wireless connection, the network/bus interface 411 can include a wireless transceiver.

As noted above, the computing device 400 also includes the storage device 440, which can comprise a single disk or a collection of disks (e.g., hard drives). In some embodiments, storage device 440 can include flash memory, semiconductor (solid state) memory or the like. The computing device 400 can also include a Random-Access Memory (RAM) 420 and a Read-Only Memory (ROM) 422. The ROM 422 can store programs, utilities, or processes to be executed in a non-volatile manner. The RAM 420 can provide volatile data storage, and stores instructions related to the operation of applications executing on the computing device 400, e.g., the image analyzer 110/gain map engine 118.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for processing a digital image, the method comprising, by a computing device:
receiving the digital image from an input source with which the computing device is communicatively coupled, wherein the digital image includes:
(i) pixel information, and
(ii) metadata that defines a plurality of properties of the digital image;
determining headroom metrics, midtone metrics, highlight metrics, shadow metrics, diffuse white metrics, or some combination thereof, based on the digital image;
adjusting a gain map for the digital image based on the headroom, midtone, highlight, shadow, diffuse white metrics, or some combination thereof, to produce a modified gain map;
producing a supplemental digital image based on the digital image and the modified gain map; and
causing the supplemental digital image to be output on a display device.

2. The method of claim 1, further comprising, subsequent to producing the modified gain map, and prior to modifying the digital image:
generating a histogram for the modified gain map;
modifying the headroom, midtone, highlight, shadow, diffuse white metrics, or some combination thereof, based on the histogram, to produce modified headroom, modified midtone, modified highlight, modified shadow, modified diffuse white metrics, or some combination thereof;
adjusting the modified gain map based on the histogram, the modified headroom, modified midtone, modified highlight, modified shadow, modified diffuse white metrics, or some combination thereof.

3. The method of claim 1, wherein the shadow metrics are determined based on at least one image capture type that is associated with the digital image and stored within the metadata.

4. The method of claim 1, wherein the diffuse white metrics are determined based on at least one material property classifier associated with the digital image, and/or at least one semantic mask associated with the digital image, that are stored within the metadata.

5. The method of claim 4, wherein the at least one semantic mask comprises a people mask, an animal mask, an eye mask, or some combination thereof.

6. The method of claim 1, wherein the gain map is generated based on two or more exposure versions of the digital image that are associated with captures of a same scene.

7. The method of claim 1, wherein the plurality of properties define characteristics of the digital image, characteristics of a scene that corresponds to the digital image, circumstances under which the scene was captured, or some combination thereof.

8. A non-transitory computer readable storage medium configured to store instructions that, when executed by at least one processor included in a computing device, cause the computing device to process a digital image, by carrying out steps that include:
receiving the digital image from an input source with which the computing device is communicatively coupled, wherein the digital image includes:
(i) pixel information, and
(ii) metadata that defines a plurality of properties of the digital image;
determining headroom metrics, midtone metrics, highlight metrics, shadow metrics, diffuse white metrics, or some combination thereof, based on the digital image;
adjusting a gain map for the digital image based on the headroom, midtone, highlight, shadow, diffuse white metrics, or some combination thereof, to produce a modified gain map;
producing a supplemental digital image based on the digital image and the modified gain map; and
causing the supplemental digital image to be output on a display device.

9. The non-transitory computer readable storage medium of claim 8, wherein the steps further include, subsequent to producing the modified gain map, and prior to modifying the digital image:
generating a histogram for the modified gain map;
modifying the headroom, midtone, highlight, shadow, diffuse white metrics, or some combination thereof, based on the histogram, to produce modified headroom, modified midtone, modified highlight, modified shadow, modified diffuse white metrics, or some combination thereof;
adjusting the modified gain map based on the histogram, the modified headroom, modified midtone, modified highlight, modified shadow, modified diffuse white metrics, or some combination thereof.

10. The non-transitory computer readable storage medium of claim 8, wherein the shadow metrics are determined based on at least one image capture type that is associated with the digital image and stored within the metadata.

11. The non-transitory computer readable storage medium of claim 8, wherein the diffuse white metrics are determined based on at least one material property classifier associated with the digital image, and/or at least one semantic mask associated with the digital image, that are stored within the metadata.

12. The non-transitory computer readable storage medium of claim 11, wherein the at least one semantic mask comprises a people mask, an animal mask, an eye mask, or some combination thereof.

13. The non-transitory computer readable storage medium of claim 8, wherein the gain map is generated based on two or more exposure versions of the digital image that are associated with captures of a same scene.

14. The non-transitory computer readable storage medium of claim 8, wherein the plurality of properties define characteristics of the digital image, characteristics of a scene that corresponds to the digital image, circumstances under which the scene was captured, or some combination thereof.

15. A computing device configured to process a digital image, the computing device comprising:
at least one processor; and
at least one memory storing instructions that, when executed by the at least one processor, cause the computing device to carry out steps that include:
receiving the digital image from an input source with which the computing device is communicatively coupled, wherein the digital image includes:
(i) pixel information, and
(ii) metadata that defines a plurality of properties of the digital image;
determining headroom metrics, midtone metrics, highlight metrics, shadow metrics, diffuse white metrics, or some combination thereof, based on the digital image;
adjusting a gain map for the digital image based on the headroom, midtone, highlight, shadow, diffuse white metrics, or some combination thereof, to produce a modified gain map;
producing a supplemental digital image based on the digital image and the modified gain map; and
causing the supplemental digital image to be output on a display device.

16. The computing device of claim 15, wherein the steps further include, subsequent to producing the modified gain map, and prior to modifying the digital image:
generating a histogram for the modified gain map;
modifying the headroom, midtone, highlight, shadow, diffuse white metrics, or some combination thereof, based on the histogram, to produce modified headroom, modified midtone, modified highlight, modified shadow, modified diffuse white metrics, or some combination thereof;
adjusting the modified gain map based on the histogram, the modified headroom, modified midtone, modified highlight, modified shadow, modified diffuse white metrics, or some combination thereof.

17. The computing device of claim 15, wherein the shadow metrics are determined based on at least one image capture type that is associated with the digital image and stored within the metadata.

18. The computing device of claim 15, wherein the diffuse white metrics are determined based on at least one material property classifier associated with the digital image, and/or at least one semantic mask associated with the digital image, that are stored within the metadata.

19. The computing device of claim 18, wherein the at least one semantic mask comprises a people mask, an animal mask, an eye mask, or some combination thereof.

20. The computing device of claim 15, wherein the gain map is generated based on two or more exposure versions of the digital image that are associated with captures of a same scene.
